(19) United States
(12) Patent Application Publication
(10) Pub. No.: US 2004/0199682 A1
(43) Pub. Date: Oct. 7, 2004

(54) Generic architecture for data exchange and data processing

(76) Inventors: Paul Guignard, Batemans Bay (AU); Steven R. Sprinkle, Austin, TX (US)

Correspondence Address: GRAY, CARY, WARE & FREIDENRICH LLP, 1221 SOUTH MOPAC EXPRESSWAY, SUITE 400, AUSTIN, TX, 78746-6875, US

(21) Appl. No.: 10/488,403

(22) PCT Filed: Sep. 3, 2002
(86) PCT No.: PCT/AU02/01194

(30) Foreign Application Priority Data
Sep. 3, 2001 (AU) PR 7414

(51) Int. Cl. G06F 3/00

(52) U.S. Cl. 710/52

(57) ABSTRACT

Data exchange between input and output ports wherein an intermediate layer translates and processes the data between the ports. The intermediate layer maps the input data into a source context attribute form. This source context form is scanned for a pattern match corresponding to patterns of mappings from the source context form to the destination context form. On pattern matching occurring, the attributes of the source context form is mapped to a destination context form. The attributes of the destination context form are then transformed into a data stream for transmission.

### TECHNICAL FIELD

This invention concerns a data exchange. In a further aspect it concerns a method of operating the exchange. The exchange may operate to interface or process data between an input and an output.

### BACKGROUND ART

All software applications can be viewed as comprising two types of operations:

1. The exchange of data from one device or component to another, from one module to another, and from one medium to another (including a human user);

2. The processing or manipulation of data in some device, module or component that changes the data's structure, organization, expression, display and/or meaning to another module, component or user. The objective of processing is to add value to the data for the benefits of its users.

In this specification we consider both exchange of data and processing. The exchange of data is an important problem in application development that has a major impact on the final cost and flexibility of solutions. This specification describes a generic way of exchanging data between any device or module or component without any programming, whatever the nature of the data involved. The processing of data is an equally important task and problem in application development. It has a major impact on the functionality, the cost and the development time required to achieve the business objectives of the software. This specification describes a generic way of defining and implementing the processing of data in application, whatever the nature of the processing and the data involved.

The exchange of data and the processing of data are fundamentally linked in applications. That is, it is impossible to exchange data without doing some processing to change the way it is expressed. Conversely, in most applications, it is important or essential to add value to the data through some form of processing (for example, sales figures need to be filtered, organized, interpreted and then presented to management). A consequence of the linkage between the exchange and processing of data is that a generic solution to one is also relevant and applicable to the other.

This invention relies and extends the invention described in the patents which are incorporated herein by reference:

Generic Knowledge Management System (GKMS, patent PCT/AU99/00501)

Intelligent Courseware Development and Delivery Environment (ICDDE, patent PR0090)

Co-pending Networked Knowledge Management and Learning (NKML, patent PR0852 and provisional patent application filed on the day as this patent)

Generic Architecture for Adaptable Software (GAAS, patent PCT/AU01/01630)

Generic Knowledge Agents (GKA, patent PCT/AU01/01631)

Meaning of Data

In this document we take the meaning of data to be quite general and to cover any entity, object or packet that we wish to process or exchange between component, module, device, etc. In this sense, data, as defined here, covers the concepts of data, information and knowledge used in the IT industry for example, however it is packaged or organized for the purpose of processing or communication. This is a powerful and convenient approach for the purpose of this specification; it is not designed to minimize the major differences in meaning and practical use between these terms. Data, information and knowledge, as used in the IT industry, can be seen as qualifiers to the entity (or data) that is the subject of this document.

Significance of the Problem

The problems of data exchange cover an important part of the effort that goes into the production of software business systems for example. Enormous sums of money are dedicated to moving data from one device, component, module, etc. to another and to cope with the way this data needs to be decoded, interpreted, understood and expressed. If one had a simple and effective way for moving this data, software development times and costs would be very significantly reduced. Other major advantages would be: a) reduced running time costs, and b) ease of maintenance and upgrade of multi-component systems (frequently, some components need to be upgraded, resulting in new compatibility and interfacing problems).

At present, there is no general way of moving data from one device to another. XML is an important step; unfortunately it requires extensive coding and does not solve the problem in a generic way as described above.

In a similar way, data processing is a time consuming and costly endeavor. The productivity of programmers is low and, in general, the software produced is difficult to maintain and adapt. The architecture presented in this specification addresses the issues of productivity, maintainability and adaptability.

### DISCLOSURE OF THE INVENTION

The invention is a data exchange comprising a data receiving port, a data transmitting port, and between the ports, an intelligent intermediate layer to interpret, translate and process data being exchanged between the two ports; where the intelligent intermediate layer has a source context and a destination context both containing attributes with allowed values arranged into patterns, and mappings that link source patterns to destination patterns, and the intelligent intermediate layer operates to map each data unit having a value and arriving at the data receiving port onto an attribute in the source context having the same or a compatible value, and then to scan the resulting patterns of attributes in the source context, and if a scanned pattern corresponds to the source region or a pattern of mappings between the source and destination contexts, to activate the mappings to map the attributes of the pattern in the source context to a pattern in the destination context, and then transform the attributes of the pattern in the destination context into a data stream for transmission.

The architecture of the intelligent intermediate layer may implement the model for knowledge representation, maintenance, updating, manipulation and associated capabilities described in the patents mentioned above.

A scanned pattern may correspond to a pattern in the destination context before the mapping is activated.

A mapping may be a knowledge item or kitem in the terminology of the above-mentioned patents. Defining the interface corresponds to defining knowledge items. Developers can specify any pattern in the source context and map it onto any pattern, or patterns, in the destination context. The set of pattern mappings (or knowledge items) specifies how the data stream is to be handled by the interface; it represents the knowledge that is to be used by the interface to interpret and translate the data from one device, component, module or medium to another. It is the interface knowledge base.

Because source context, destination context and knowledge items can be defined without any programming (see the above-mentioned patents), developers can easily and conveniently develop interfaces that are not hard-coded and that can be modified easily.

The unit of the data stream that is mapped can vary, from a byte to more complex entities such as database fields and objects. The range of values that the attribute in the context can take is the range of values that the unit of data can take.

It is possible for a knowledge element to have as output a pattern that changes the behaviour of the interface itself.

The data exchange may be used for data processing, or for interfacing data, the interfacing may operate in both forward and return directions.

The source and destination contexts may contain descriptions of communication devices that can be connected to the interface, in which case provided a received data stream contains an identifier for its originating device and target devices the interface may exchange data between those devices.

In a similar way, it may be appropriate for the data stream to contain the source and destination addresses of the data stream.

The exchange may determine which knowledge items are applicable to a pattern in the source context by checking all the source patterns in all the knowledge items in the knowledge base. Alternatively, the interface may index the knowledge items to the source patterns they relate to. It may index the destination patterns of these knowledge items rather than the knowledge items themselves, and link them to the corresponding source patterns. The advantage of indexing is that the Application Program Interface (API) does not need, at operations time (that is, when it has to determine which knowledge items are applicable) to check all the knowledge base; only a table lookup is necessary.

The exchange may build the index, adding destination patterns to new, compatible, source patterns found in an incoming data stream.

The exchange may dynamically re-organize the order of the indexes in the table to put the most frequently used patterns at the top of the table in order to reduce processing times.

In practice, the exchange may check the index to see if a pattern detected in the source context is present; it then checks all the source patterns associated with all the knowledge items not yet indexed to see if any is compatible with the source pattern detected in the data stream. If it finds any compatible knowledge items, it indexes them by adding their destination contexts to the index. In a similar way, the interface may check the lists of knowledge elements that have been modified since the last check, to see if any in the index needs updating. If a knowledge element in the knowledge base has been disabled since the last check, it may be removed from the index.

The exchange may dynamically re-organize the order of the indexes in the table to put the most frequently used patterns at the top of the table in order to reduce processing times.

The exchange may scan the input stream for patterns that indicate that an error in transmission has taken place.

The exchange may scan the input stream for patterns that relate to an unknown or suspicious origin and/or destination.

The exchange may keep a running record of the knowledge items used.

In a further aspect, the invention is a method of operating a data exchange comprising a data receiving port, a data transmitting port, and between the ports, an intelligent intermediate layer to interpret and translate the data being exchanged between the two ports; where the intelligent intermediate layer has a source context and a destination context both containing attributes with allowed values arranged into patterns, and mappings between source patterns in the source context and destination patterns in the destination context; the method comprises the steps of:

receiving data units having values at the data receiving port;

mapping the data units onto attributes in the source context having the same or a compatible value;

scanning the resulting patterns of attributes arriving in the source context;

mapping attributes of the scanned pattern to a pattern in the destination context when a scanned pattern corresponds to a pattern of mappings between the source and destination contexts, then,

transforming the attributes of the pattern in the destination context into a data stream for transmission.

### BRIEF DESCRIPTION OF THE DRAWINGS

FIG. 1 is a block diagram showing the known architecture for data exchange.

The invention will now be described with reference to the following drawings, in which:

FIG. 2 is a block diagram showing a generic architecture for data exchange.

FIG. 3 is a block diagram showing the architecture of a generic applications program interface.

FIG. 4 is a block diagram showing the data and pattern mapping in the generic applications program interface.

FIGS. 5(a), (b) and (c) show different forms of a two way generic applications program interface.

FIG. 6 is a block diagram showing a generic data exchange switch.

FIG. 7 is a block diagram showing a generic architecture for data processing.

FIG. 8 is a block diagram showing data processing as pattern mappings.

FIG. 9 is a block diagram showing a typical architecture for a software product.

FIG. 10 is a block diagram of a generic applications program interface and data processing in a database end user interface.

FIG. 11 is a block diagram of a database access using a generic applications program interface and data processing and its pattern mappings.

FIGS. 12(a), (b) and (c) are a block diagram of a generic applications program interface and data processing for data access.

FIG. 13 is a block diagram of an intermediate layer to interpret the database schema.

### BEST MODES OF THE INVENTION

Generic Architecture for Data Exchange

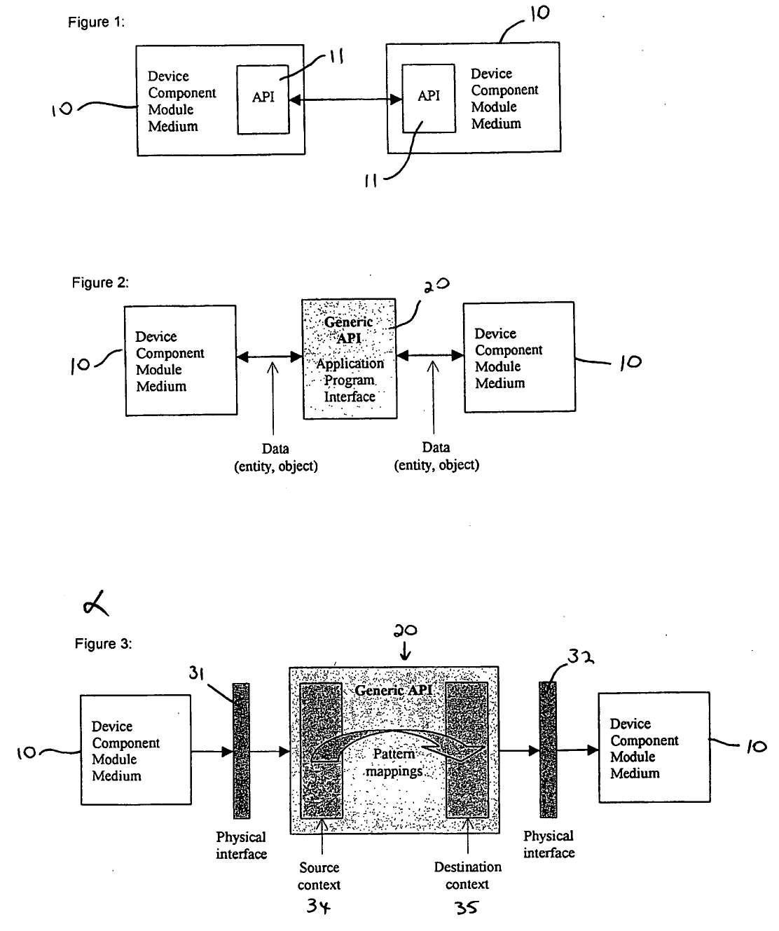

The architecture of the invention as shown in FIG. 2 differs from the usual way, shown in FIG. 1, of exchanging data between modules 10. In FIG. 1 the modules each include a specific interface 11. The main difference is the introduction of an ‘intelligent’ intermediate layer or component 20 between the two modules 10. Also, the interfaces 11 specific to the modules 10 have been removed. The intelligent intermediate layer 20 has the role of ‘interpreting’ and ‘translating’ the data being exchanged between the two modules 10 rather than the exchange occurring directly between them. The architecture of this ‘intelligent’ layer 20, labelled the Generic API in FIG. 2, implements the model for knowledge representation, maintenance, updating, manipulation and associated capabilities described in the patents mentioned above.

FIG. 3 shows the architecture of the Generic API 20 when data is being exchanged between two modules 10. Physical interfaces or connectors 31 and 32 are each linked to a different module 10 and also to the Generic API 20 itself. Within the Generic API 20 two contexts are provided, a source context 34 and a destination context 35.

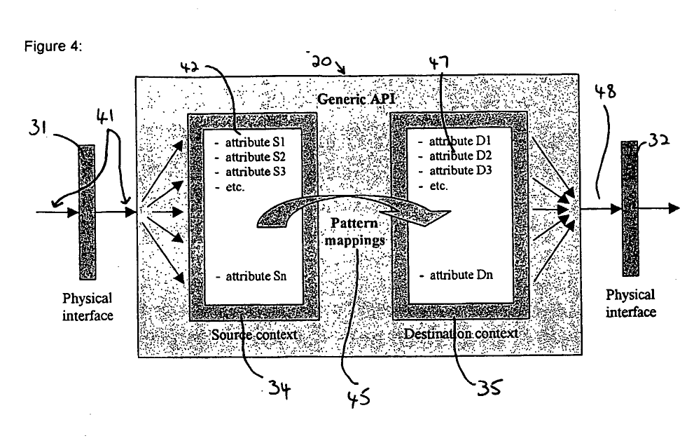

Referring now to FIG. 4, the arrows 41 on either side of the physical 31 interface on the left represent a serial or parallel stream of data originating from a data transmitting port or module 10 and having a data receiving port or module 10 as its destination. This data stream 41 passes through the physical interface 31 and is mapped onto attributes 42 within the source context 34 of the Generic API 20. The unit of the data stream that can be mapped varies, from a byte to more complex entities such as database fields and objects. The range of values that the attribute in the context can take is the range of values that the unit of data can take. It follows that the actual value of an attribute is the value of a unit of data that is mapped onto that attribute. A set of attributes 42 defines a pattern in the source context.

The Generic API 20 is defined by the ‘pattern mappings’ 45. These mappings 45 determine how the patterns in the source context 34 are mapped, as patterns, onto the destination context 35 that is going to produce the output. A mapping is a knowledge item or kitem in the terminology of the above-mentioned patents. Defining the interface corresponds to defining knowledge items. Developers can specify any pattern in the source context 34 and map it onto any pattern in the destination context 35. The set of pattern mappings (or knowledge items) 45 is the interface knowledge base. It specifies how the data stream is to be handled by the Generic interface; it represents the knowledge that is to be used by the Generic API 20 to interpret and translate the data from one device, component, module or medium to another.

Both the source context and destination context can be organized hierarchically using folders for example, as in a file system.

The Generic API 20 contains an ‘engine’ that scans the patterns (sets of attributes 42) arriving in the source context 34 to see if any matches one or several of the source patterns (sets of attributes 47) defined by the developer (as part of the pattern mapping) and stored in the interface knowledge base (set of pattern mapping 45). When it finds such a pattern, it activates the mappings (knowledge items) corresponding to the matching patterns. The patterns so activated define/produce the patterns in the destination context 35 that become the interface output.

The resulting output is transformed into a data stream 48 that is passed through the physical interface 32 to the destination port, component, module or medium 10.

Because source context 34, destination context 35 and pattern mappings (knowledge items) 45 can be defined without any programming (see above-mentioned patents), developers can easily and conveniently develop interfaces that are not hard-coded and that can be modified easily.

Dynamic API Behaviour Change

It is possible for a knowledge item 45 to have as output a pattern that changes the behavior of the API 20 itself. For example the output pattern could instruct the API 20 not to scan the input stream 41 for patterns for n number of entity (bits, bytes, objects, etc.) or until another known pattern is detected. This could be advantageous when the data stream 41 is made of packets that contain data between markers. Once the first marker is detected and interpreted, the API 20 simply counts the number of entities passing through it or waits until it detects the end marker (or tag). This use of knowledge to dynamically change the behaviour of a system on the fly, can be applied to all systems built using the patents mentioned previously.

Two-way Generic API

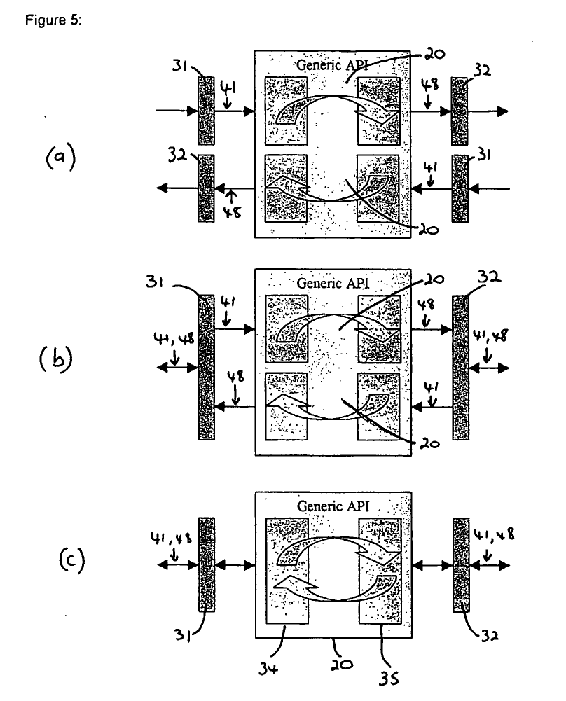

In practice, developers need to exchange data not only in one direction (as in FIG. 4) but in two directions. Referring now to FIG. 5(a), a two-way Generic API may simply comprise two Generic APIs 20 where each Generic API 20 is associated with a separate set of interfaces 31, 32, an input data stream 41 and output data stream 48. Alternatively, the design can be simplified, depending on the level of symmetry that exists between the left-right and right-left exchanges. For instance, as shown in FIG. 5(b) the two API's 20 could share the same interfaces 31, 32 but each having a separate input data stream 41 and an output data stream 48. A further alternate arrangement is shown in FIG. 5(c) where a single API 20 is provided with one set of interfaces 31, 32 allowing both the input 41 and output 48 data streams to be routed along the same path. In this arrangement the source 34 and destination 35 contexts can interchange depending on the direction of the data flow. This can impose restrictions in the timing of the exchanges and their directions.

Exchanges Between a Variety of Modules: The Data Exchange Switch

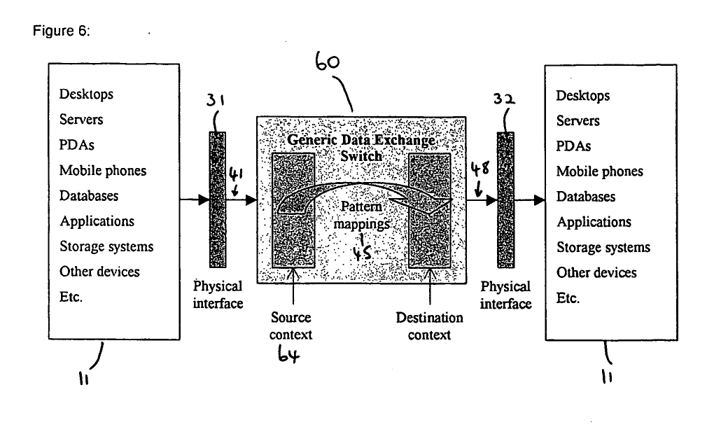

Current trends in decentralization, globalization, customer service and a mobile workforce require data exchanges to take place between a variety of modules (devices) simultaneously. For example, data from a mainframe may need to go to a desktop window-based display application, a browser on a laptop, a display program on a PDA (personal digital assistant) or a mobile phone. It would be advantageous if a single user interface could handle all these exchanges dynamically, while preserving the advantages listed above. FIG. 6 illustrates the Generic Data Exchange Switch (Generic DES) 60, based on the architecture described above and generalizing it to deal with an arbitrary range of different modules.

The Generic DES 60 above can be a two-way Generic API. A source context 64 contains a description of the modules that can be connected to the Generic DES 60. In order to achieve the desired switching effect, the data stream 41, originating from the left, needs to contain an identifier that specifies the particular device, component or module 11 that the data 41 is from along with some identifiers that specify the devices, components or modules 11 the data is to be mapped to. The Generic DES 60 can allow for more than one device, component or module 11 to be specified as the destination. These identifiers have to be part of the data stream 41 (part of the data packet for example). This enables the Generic DES 60 to determine the source and destination and to select the pattern mapping 45 (knowledge items) that are going to interpret the input stream 41 according to its source format and translate it to the destination module 11 formats.

In a similar way, it may be appropriate for the data stream to contain the source and destination addresses of the data stream.

The advantage of the architecture illustrated in FIG. 6 is that a single model and implementation of the Generic DES 60 can handle dynamically a very large variety of exchanges between a very large variety of components, devices, modules, etc. Furthermore, this complex system can be developed without any programming; is easy to maintain and update.

Generic Architecture for Data Processing (APD)

Generic ADP is similar to the invention described in FIGS. 2, 3, 4 and 5, in which the terms ‘Generic API’ and ‘Generic Data Exchange Switch’ are replaced by ‘Generic ADP’ and the physical interfaces 31, 32 are removed. The Generic ADP implements the GKMS model and that of the other patents mentioned previously.

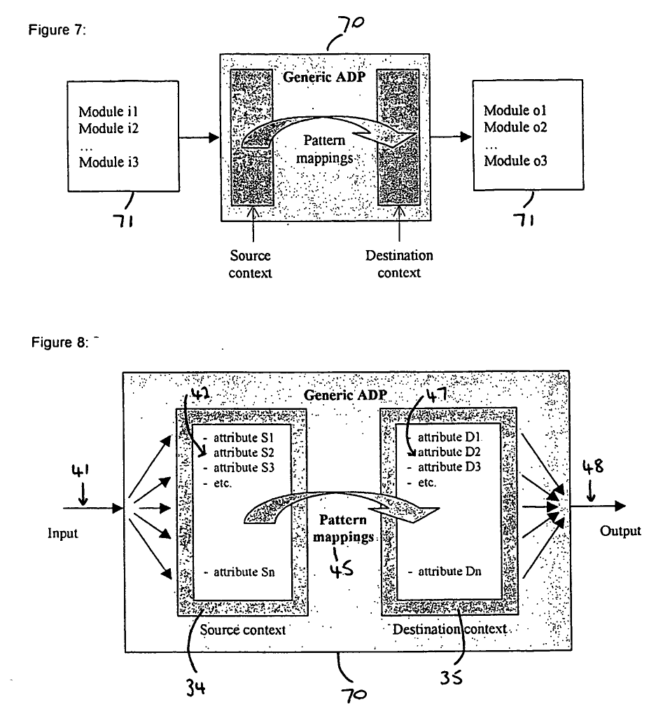

FIG. 7 shows the architecture for the Generic ADP 70 where a Generic ADP 70 is located between two modules 71. FIG. 8 shows the application of the pattern matching 45 described above in reference to FIG. 3 being applied in the context of data processing. An input data stream 41 is mapped onto attributes 42 within the source context 34 of the Generic APD 70. These are then pattern matched 45 to the attributes 47 of the destination context 35 to create a data output stream 48.

Use of the Generic API and Generic APD Combined

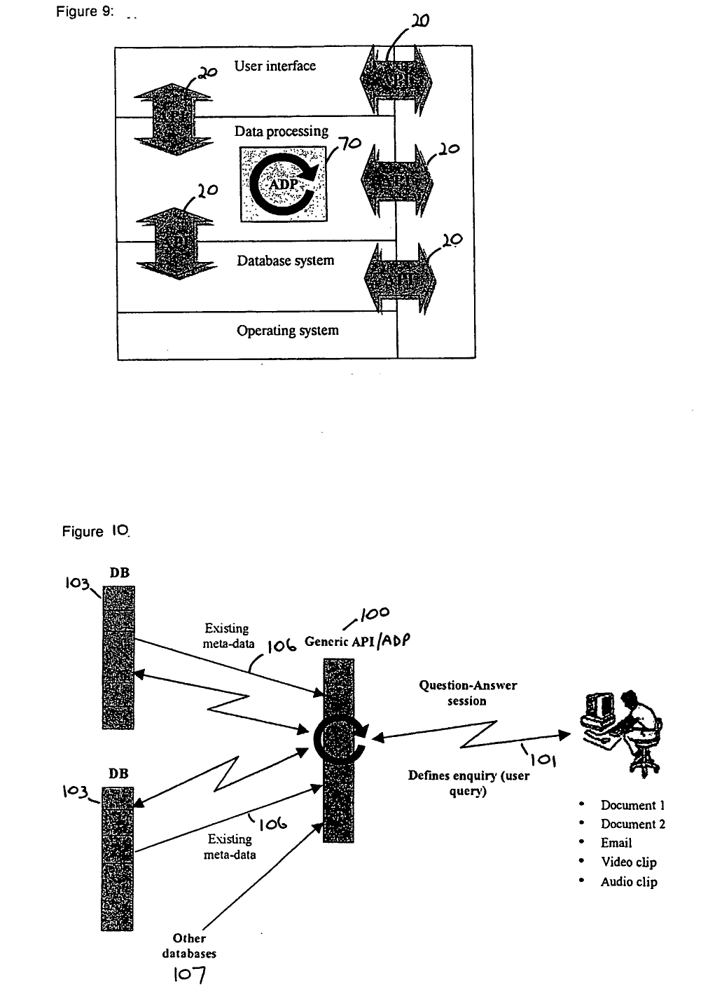

A general architecture for software exchange and processing using both the Generic API and the Generic ADP is shown in FIG. 9. Generic APIs 20 can be used to connect separate tiers of the hierarchy within a software product. Further Generic APIs 20 can be provided to connect separate tiers of the software product to an overall bridging layer. A Generic ADP 70 is also included within the data processing tier of the software product. This general architecture can be used to build around any application and software package or to build one from scratch.

Learning and Other Value Adding Processing

The Generic API 20 (and therefore the Generic DES 60) and the Generic ADP 70 can take advantage of the knowledge model they are based on to perform value-adding functions

Learning by Indexing

A typical knowledge engine (see previously mentioned patents) determines which knowledge items are applicable to a pattern in the source context by checking (very efficiently) all the source patterns in all the knowledge items in the knowledge base. Another way is for the API to index the knowledge items to the source patterns they relate to. It can also be very advantageous to index the destination patterns of these knowledge items rather than the knowledge items themselves. The advantage of indexing is that the API does not need, at operations time (that is, when it has to determine which knowledge items are applicable) to check all the knowledge base; only a table lookup is necessary.

The API can build the index gradually. Each time a new source pattern from the data stream is found to be compatible with some knowledge items in the knowledge base the API index these knowledge items (or their destination patterns) to the data stream pattern.

An alternative to building the index gradually is to get the API to index all the knowledge items in the knowledge at one time.

In practice, the API checks the index to see if the pattern detected in the source context is present; it then checks all the source patterns associated with all the knowledge items not yet indexed to see if any is compatible with the source pattern detected in the data stream. If the API finds any compatible knowledge items, it indexes them (adds them or their destination contexts to the index). In a similar way, the API checks the lists of knowledge elements that have been modified since the last check, to see if any in the index needs updating. If a knowledge element in the knowledge base has been disabled since the last check, it is then removed from the index.

The exchange may dynamically re-organize the order of the indexes in the table to put the most frequently used patterns at the top of the table in order to reduce processing times.

The learning described above is applicable to all systems and applications that use the pattern-based modeling described in the patents mentioned previously. Each knowledge item has a property that describes whether it belongs to the index. Several index files could be built.

Further learning mechanisms such as meta knowledge: observe, recognize patterns in the patterns fired and prepare the processing can also be used Other value-adding processing examples include:

Error Checking

The Generic API can scan the input stream for patterns that indicate that an error in transmission has taken place. When one is detected, the API can then either correct the error or, if necessary, ask for a retransmission. The above implies that the API contains the appropriate knowledge elements to detect the errors, correct them if possible and/or manage the retransmission.

Security

The Generic API can scan the input stream for patterns that relate to an unknown or suspicious origin and/or destination. When such a pattern is detected, it triggers some knowledge items in the API that block the transmission, inform some administrators and take whatever action is deemed appropriate and that was expressed as knowledge elements in the API.

Reporting

The Generic API can keep a running record of the knowledge items used (fired or triggered by the patterns detected). This can be communicated automatically to some administrators at some specific times or when some patterns are detected in the input data stream, the workload, the type of data, etc. All these operations are implemented with knowledge items.

Content Checking

This is a particular implementation where the objective is to detect some patterns in the input data stream that is contained between the markers of a data packet for example.

### APPLICATION EXAMPLES

eXtensible Markup Language (XML) and eXtensilble Stylesheet Language (XSL)

Both XML and XSL (including XSL Transformation) can be mapped into the Generic API. The mapping is represented in Table 1.

TABLE 1
Mapping of XML and XSL onto the Generic API

| XML and XSL | Generic API |
|---|---|
| XML Schema or Document | Source context |
| Type Definition | (hierarchical structure of all the attributes in |
| | the Schema or DTD) |
| XML tag | An attribute in the source context |
| XML element | A pattern in the source context |
| XML document | A set of pattern in the source context |
| XSLT source document | A set of patterns in the source context |
| (XML document) | |
| XSLT destination | A set of patterns in the destination context |
| document (e.g. | |
| HTML document) | |
| XSLT template | A knowledge item (or several knowledge |
| | items) that maps a source pattern (XML |
| | element) into a destination pattern (HTML |
| | element) |
| Transformation process | Run the Generic API engine |
| | Find which knowledge elements are |
| | compatible (match) the source patterns |
| | (XML elements) |
| | Take/apply the destination patterns of these |
| | knowledge elements (belong to the |
| | destination context) |

In the descriptions above and below, one could replace Generic API with the ‘GKMS’ model disclosed in the first GKMS patent (see above).

The advantages of mapping XML and XSL onto the Generic API are those described previously in relation to the invention and in the previous specifications. In practice, the advantages are:

Define the contexts and patterns in XML without any programming. The developer can express Schemas and DTDs and in plain language; the Generic API then adds the syntax to make them compatible with the XML standard. For example

a DTD item <to> only needs to be defined as ‘to’, the ‘<’ and ‘>’ can be added automatically;

an element ‘Jim’ (a value given to the DTD item ‘to’) will result automatically in <to>Jim</to>

Define the destination context and patterns for the destination without any programming. As above, the DTDs and the elements can be defined in plain language; the Generic API can add the appropriate syntax.

Database Interfacing

In this example we consider an interface between a human and a database and show that the Generic API/ADP is a powerful, flexible and adaptable user interface. The results obtained can be generalized to user interfaces for a very large number of software and hardware applications and for other types of machinery and equipment. Interfaces that do not involve human operators or users can also be implemented in the way described below.

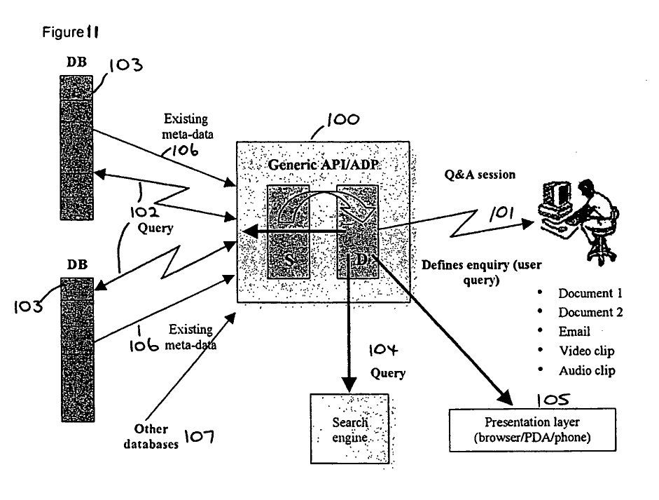

FIG. 10 illustrates how the Generic API/ADP 100 can be used to interface with databases 103. The meta-data from the databases 103 is imported 106 into the Generic API/ADP 100 as source context. The meta-data comprises the data dictionary which includes the fields and their types that specify the records in all the tables in the database (for other types of databases, it contains the keys that enable users to retrieve the data or records in the database). Any record in the database can be mapped as a pattern in the source context of the Generic API/ADP 100. That is, all the records can be represented as patterns in the API/ADP 100. Any source context pattern defined by the user can be used to query 101 the database and retrieve the appropriate records in it.

The process for defining the user enquiry is a question-answer session 101 of the type described in the patents mentioned previously. The Q&A session 101 is an essential part of the GKMS model that enables system to query users about their needs, based on what the system knows it has in its database 103 or in the connected databases 107. The process of defining user needs 101 can be carried out without connection to the databases 103. It is only when the enquiry is defined that the Generic API/ADP 100 queries the databases 103, using SQL for example, to retrieve the relevant records and to present them to the user. (The circular arrow indicates that the Generic API/ADP 100 is performing some actions).

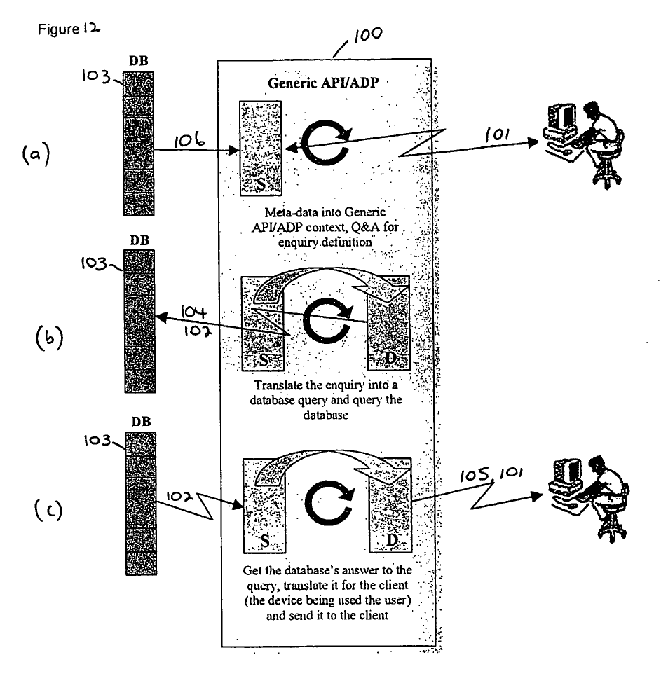

Table 2 shows the process involved in connecting and using the Generic API/ADP as interface to databases. FIG. 11 illustrates the process in more details.

TABLE 2
The Generic API/ADP as database user interface for data access

| Steps | Generic API/ADP |
|---|---|
| Import databases meta-data 106 into | The meta-data (tables, fields, types |
| the API/ADP's 100 source context | and allowed values) is mapped as the context |
| Use Q&A process 101 to get users to | The Q&A process can take place |
| define their requirements (there is no | without any live connection with the |
| active connection to the databases in | databases. |
| that process) | The enquiry is defined as a pattern in |
| | the source context (users specify their |
| | enquiries by giving values to the |
| | attribute in the context, that |
| | corresponds to fields in the database) |
| Transform the enquiry into a query 104 | For example transform the pattern into |
| (or queries) that can be understood by | a SQL query (or a set of SQL queries if |
| the database(s) | there is more than one database) |
| Send the query (or queries) 102 to the | |
| database(s) 103 | |
| The databases 103 return the results of the | |
| query (or queries) 102 to the | |
| Generic API/ADP 100 | |
| The Generic API/ADP 100 transforms | The Generic API/ADP can |
| the results into a format that can be | accommodate a large number of |
| understood by the client or user 105 | different devices |
| The Generic API/ADP 100 passes the | |
| results to the client or user 105 | |

FIG. 11 illustrates how database access can take advantage of the pattern mapping described previously. Several pattern mappings take place and the labelled arrows illustrate their use.

1. The user enquiry 101 is transformed into a SQL query for example and used to query 102 the databases 103. This is achieved using pattern mappings.

2. The user enquiry can be transformed into any other pattern that is compatible with any other device, for example a search engine 104. This means that once the enquiry is specified, it can be translated into any other enquiry for any data access device (for example a free text search module) and sent to it for carrying out the search.

3. Once the results of the enquiry are received, they can be transformed from the formats corresponding to their devices (databases, search engine, etc.) into the format(s) appropriate to the devices the users are currently using to view and interact with the data, such as browsers, a personal digital assistants or a phones 105.

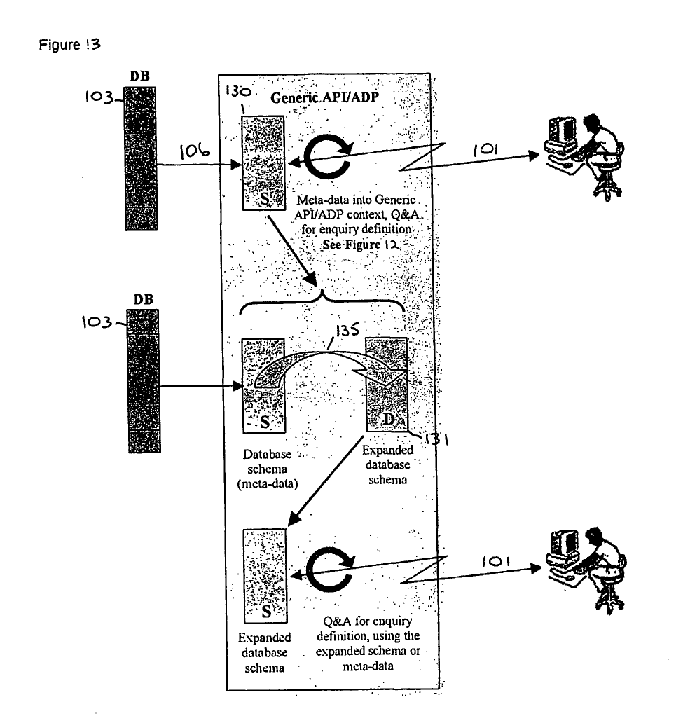

Referring to the FIG. 12, a single database 103 represents any number of databases and the different source and destination contexts can be either different contexts of part of a larger source and destination context. FIG. 12 shows the three types of mappings taking place in the Generic API/ADP 100 in FIG. 11. FIG. 12(a) shows the importation 106 of the databases 103 metadata and Q&A process 101 for enquiry definition. FIG. 12(b) shows the transforming 104 of a query so that it can be understood by the database 103 and then sending it 102 to the database 103. FIG. 12(c) shows the returning of the results of the query 102 to the Generic API/ADP 100, translating it for the client's module 105 and sending it to them 105.

Using Generic DES for Specifying Database Schemas and Entering Data

To define and update database schemas the process is the reverse of the one discussed previously above and in reference to FIGS. 10, 11 and 12. Instead of importing the meta-data, the process is one where the database schemas are defined as contexts and then exported to the databases.

TABLE 3
The Generic API/ADP as database user
interface for schema definition

| Steps | Generic API/ADP |
|---|---|
| Enter the fields, with their types and | Each field is a context element |
| allowed values, that need to be stored | in the source context |
| in the database | |
| Enter the knowledge elements | The transformed fields are part |
| (mappings) that define the way the | of the destination context |
| fields need to be coded into an | This is done once for all the |
| expression that the database can | fields that form the database |
| understand and use to create the field | schema |
| needed in the database | |
| Define a source context element to be | When clicked, the button |
| used as button to activate the operation | activates the knowledge |
| that transfers the expression to the | engine, that uses the knowledge |
| database | elements that map the fields |
| | into the expression for the |
| | database to carry out the |
| | transformation |

Entering Data into Databases

Once a context is defined and the database schemas specified, the developer can define knowledge elements (each comprising a source pattern and, optionally, a destination pattern). The knowledge elements define the fields that the user interface, via the Generic API/ADP, will ask the user to fill in for it to store in the database.

These knowledge elements, when used by the Generic API/ADP in a question-answer mode according the GKMS model, produce dynamic forms for the user to fill in, that adapt at run time to the users' needs or situation (see GAAS patent).

Once the consultation has taken place, the dynamic form is filled. The Generic API/ADP then transforms the form and its content (using separate mappings based on other knowledge elements) into a format that the database can understand. It then sends the data to the database(s), which updates its contents.

TABLE 3
The Generic API/ADP as database user interface for data entry

| Steps | Generic API/ADP |
|---|---|
| Enter the knowledge elements | The transformed fields are part |
| (mappings) that define the way the | of the destination context |
| fields need to be coded into an | This is done once for all the |
| expression that the database can | fields that form the |
| understand and use to store the fields | database schema |
| in the database | |
| Enter knowledge elements that define | Standard GKMS application |
| (that contain the knowledge about) the | |
| way the dynamic form should be | |
| generated | |
| Define a source context element to be | The transformed fields are |
| used as button to activate the data | part of the destination context |
| entry operation | |

The descriptions above can be generalized to more than a single database. That means that it is possible, via a single user interface, to define schemas for a variety of databases. It is also possible to create dynamic forms for capturing data that can be stored in more than one database (some field in a database and some in another database for example).

Intermediate Layer to Interpret the Database Schema

It can happen that the database schema (or meta-data) in a database is not very user-friendly. For example, in a spare parts database, part numbers could be used to identify both parts and records. Part numbers could be a concatenation of several short strings, such as module number, sub-module number and part code. Finding a part in the database requires specialized knowledge.

An alternative is to insert an intermediate layer between the record identifiers and the users that interprets the database schema. In our example, the intermediate layer decomposes the record identifier into its components. The system then uses the expanded database schema to run the question-answer session. When the user needs are identified, the system combines the answers to the questions relating to module, sub-module and part code, before building the query string to be used to query the database. With reference to FIG. 13, the first source context 130 is expanded to include the intermediate layer. This is done by defining the expanded database schema as a destination context 131. The mapping or relationship between the schema and the expanded schema is described using knowledge elements 135 that link patterns in the source context (schema or meta-data) to the destination context (expanded schema or meta-data) 131.

Advantages of Using the Generic API/ADP as Interface to Databases

The Generic API/ADP, based on the descriptions in this document, make it possible to perform operations, without programming, that are very powerful and commercially important.

Database Access

A single user interface can access data in multiple databases, each having its own schemas and communication protocols

A single query can access data from multiple databases simultaneously, without the user being aware of it

Access is via simple question and answer (Q&A) session

Queries based on tables or other static definitions or frameworks are replaced by a dynamic and flexible way for specifying requirements (GKMS process)

Only necessary questions are asked of the user (minimal effort for access)

This is a powerful way to gain access to legacy data in organizations

Database Schema Definition

A single user interface can be used to define or update schemas in different databases with different communication protocols

The process to transform the fields in a way that is understandable by each database to create/update its schema is defined as a set of knowledge elements

Database Data Entry

A single user interface can be used to enter data in a variety of databases

Dynamic forms can be produced that adapt to the situation the user is in and the specify the type of data that needs to be entered

Dynamic forms can relate to different fields in different databases, without the data entry operator or user being aware of it

When form is filled, the Generic API/ADP stores the data in the corresponding databases automatically

One can consider the Generic API, the Generic DES and the Generic ADP as special implementations of the models and techniques described in the GKMS and other patents. It is in fact correct and this specification describes how to use the features of the GKMS and other patents to implement the Generic API, the Generic DES and the Generic ADP.

With respect to the co-pending NKML patent no PR0852, all the exchanges described in this specification take place in networked environments where the exchanges of information and the behavior of the processes in the relevant nodes or clients or machines or devices depend on the behavior in other nodes or clients or machines or devices. The patent description relies on the description in patent PR0852.

1. A data exchange comprising a data receiving port, a data transmitting port, and between the ports, an intelligent intermediate layer to interpret, translate and process data being exchanged between the two ports; where the intelligent intermediate layer has a source context and a destination context both containing attributes with allowed values arranged into patterns, and mappings that link source patterns to destination patterns, and the intelligent intermediate layer operates to map each data unit having a value and arriving at the data receiving port onto an attribute in the source context having a compatible value, and then to scan the resulting patterns of attributes in the source context, and if a scanned pattern corresponds to a pattern of mappings between the source and destination contexts, to activate the mappings to map the attributes of the pattern in the source context to a pattern in the destination context, and then transform the attributes of the pattern in the destination context into a data stream for transmission.

2. A data exchange according to claim 1, where the source pattern corresponds to a pattern in the destination context before a mapping between the two is activated.

3. A data exchange according to claim 1 or 2, where each mapping is a knowledge item, or kitem, and where defining the intelligent intermediate layer corresponds to defining knowledge items.

4. A data exchange according to claim 1, 2 or 3, where patterns in the source context and mappings to patterns in the destination context are specified by developers.

5. A data exchange according to any one of the preceding claims, where the range of values that an attribute in the source context can take is the same as the range of values that a unit of data can take.

6. A data exchange according to claims 3, where a knowledge item has as an output a pattern that changes the behaviour of the intelligent intermediate layer itself.

7. A data exchange according to any one of the preceding claims, used for data processing.

8. A data exchange according to any one of the preceding claims, used for interfacing data.

9. A data exchange according to claim 8 or 9, operating in both forward and return directions.

10. A data exchange according to any one of the preceding claims, where the source and destination context contain descriptions of different communication devices, and provided a received data stream contains an identifier for its originating device and target devices, the intelligent intermediate layer exchanges data between those devices.

11. A data exchange according to any one of the preceding claims, where the data stream contains source and destination addresses.

12. A data exchange according to claim 3, where the intelligent intermediate layer determines which knowledge items are applicable to a pattern in the source context by checking all the source patterns.

13. A data exchange according to claim 3, where the intelligent intermediate layer indexes the knowledge items to the source patterns they relate to and indexes the destination patterns of these knowledge items.

14. A data exchange according to claim 13, where the index is built by adding destination patterns to new, compatible, source patterns found in the incoming data stream.

15. A data exchange according to claims 13 or 14, where the index is checked to see if a pattern detected in the source context is present; then all the source patterns associated with all the knowledge items not yet indexed are checked to see if any is compatible with the source pattern detected in the data stream, and if any compatible knowledge items are found, they are indexed by adding their destination contexts to the index; and the lists of knowledge elements that have been modified since the last check, are checked to see if any in the index need updating; and if a knowledge element in the knowledge base has been disabled since the last check, is removed from the index.

16. A data exchange according to any one of the preceding claims, where the intelligent intermediate layer scans the incoming data stream for patterns that indicate that an error in transmission has taken place.

17. A data exchange according to any one of the preceding claims, where the intelligent intermediate layer scans the incoming data stream for patterns that relate to an unknown or suspicious origin or destination.

18. A data exchange according to any one of the preceding claims, where the intelligent intermediate layer keeps a running record of the knowledge items used.

19. A method of operating a data exchange comprising a data receiving port, a data transmitting port, and between the ports, an intelligent intermediate layer to interpret and translate the data being exchanged between the two ports; where the intelligent intermediate layer has a source context and a destination context both containing attributes with allowed values arranged into patterns, and mappings between source patterns in the source context and destination patterns in the destination context; the method comprises the steps of:
receiving data units having values at the data receiving port;
mapping the data units onto attributes in the source context having a compatible value;
scanning the resulting patterns of attributes arriving in the source context;
mapping attributes of the scanned pattern to a pattern in the destination context when a scanned pattern corresponds to a pattern of mappings between the source and destination contexts, then,
transforming the attributes of the pattern in the destination context into a data stream for transmission:

20. A method of operating a data exchange according to claim 19, where the source pattern corresponds to a pattern in the destination context before the mapping is activated.

21. A method of operating a data exchange according to claim 19 or 20, where mapping is a knowledge item, or kitem, and where defining the intelligent intermediate layer corresponds to defining knowledge items.

22. A method of operating a data exchange according to any one of claims 19, 20 or 21, where developers specify patterns in the source context and mappings to patterns in the destination context.

23. A method of operating a data exchange according to one of claims 19 to 22, where the range of values that the attribute in the context can take is the range of values that the unit of data can take.

24. A method of operating a data exchange according claim 21, where a knowledge item has as an output a pattern that changes the behaviour of the intelligent intermediate layer itself.

25. A method of operating a data exchange according to any one of claims 19 to 24, used for data processing.

26. A method of operating a data exchange according to any one of claims 19 to 25, used for interfacing data.

27. A method of operating a data exchange according to claim 25 or 26, operating in both forward and return directions.

28. A method of operating a data exchange according to any one of claim 19 to 27, where the source and destination context contain descriptions of different communication devices, and provided a received data stream contains an identifier for its originating device and target devices the intelligent intermediate layer exchanges data between those devices.

29. A method of operating a data exchange according to any one of claims 19 to 28, where the data stream contains the source and destination addresses.

30. A method of operating a data exchange according to claim 21, where the intelligent intermediate interface determines which knowledge items are applicable to a pattern in the source context by checking all the source patterns.

31. A method of operating a data exchange according to claim 21, where the intelligent intermediate layer indexes the knowledge items to the source patterns they relate to and indexes the destination patterns of these knowledge items.

32. A method of operating a data exchange according to claim 31, where the index is built by adding destination patterns to new, compatible, source patterns found in the incoming data stream.

33. A method of operating a data exchange according to claim 31 or 32, where the index is checked to see if a pattern detected in the source context is present; then all the source patterns associated with all the knowledge items not yet indexed are checked to see if any is compatible with the source pattern detected in the data stream, and if any compatible knowledge items are found, they are indexed by adding their destination contexts to the index; and the lists of knowledge elements that have been modified since the last check are checked, to see if any in the index need updating; and if a knowledge element in the knowledge base has been disabled since the last check, it is removed from the index.

34. A method of operating a data exchange according to any one of claims 19 to 33, where the intelligent intermediate layer scans the input stream for patterns that indicate that an error in transmission has taken place.

35. A method of operating a data exchange according to any one of claims 19 to 34, where the intelligent intermediate layer scans the input stream for patterns that relate to an unknown or suspicious origin or destination.

36. A method of operating a data exchange according to any of claims 19 to 35, where the intelligent intermediate layer keeps a running record of the knowledge items used.
